(19) United States
(12) Patent Application Publication
(10) Pub. No.: US 2012/0092220 A1
(43) Pub. Date: Apr. 19, 2012

(54) ANTENNA APPARATUS AND ELECTRONIC DEVICE

(75) Inventors: Kazuya TANI, Osaka (JP); Yasuharu MATSUOKA, Osaka (JP); Toshiharu ISHIMURA, Osaka (JP); Kouji WATANABE, Hyogo (JP)

(73) Assignee: PANASONIC CORPORATION, Osaka (JP)

(21) Appl. No.: 13/272,925

(22) Filed: Oct. 13, 2011

(30) Foreign Application Priority Data
Oct. 14, 2010 (JP) 2010-231665

(51) Int. Cl. H01Q 7/00; H01Q 1/48; H01Q 1/24

(52) U.S. Cl. 343/702; 343/848; 343/866

(57) ABSTRACT

An antenna apparatus is provided with a first antenna element, a second antenna element, a first ground element, a first ground plane and a second ground plane each formed by a conductive pattern. The first antenna element and the second antenna element are electrically connected by a first through-hole, and also form a first capacitive coupling portion in which they partially overlap across a substrate and are capacitively coupled. Such a configuration enables the antenna apparatus to be realized at low cost, since an antenna can be formed with only a substrate and conductive patterns, without requiring additional elements such as sheet metal. The antenna apparatus also can be reduced in profile and size, since only the conductive patterns are formed on a first surface and a second surface of the substrate, and there are no members that project significantly from the plane of the substrate.

### BACKGROUND OF THE INVENTION

1. Field of the Invention

The present application relates to an antenna apparatus and an electronic device provided with the antenna apparatus.

2. Description of Related Art

Recent years have seen mobile phones and wireless LANs become generally available and various services developed, and it is expected that more and more convenient wireless services will continue to be provided in the future.

In order to respond to these improvements in communication capacity and communication speed, introduction of a new communication method LTE (Long Term Evolution) is being considered. LTE is likely to share frequency bands with the conventional wideband wireless system W-CDMA (Wideband Code Division Multiple Access), and individual countries are planning new frequency allocation of the UHF (Ultra High Frequency) band favorable for wireless communications, such as 704 to 746 MHz, 746 to 787 MHz, 1427.9 to 1500.9 MHz, 2.3 to 2.4 GHz, and 2.5 to 2.69 GHz, for example, to supplement the frequency bands on which conventional WWANs (Wireless Wide Area Networks) operate.

Since LTE has the advantage of being able to support global roaming that enables wireless apparatuses to be utilized in different countries by being equipped with a communication module and an antenna compatible with a plurality of the above frequencies, and bypass having to design specifically for individual countries, the demand for antennas with increased bandwidth that operate on multiple bands is rising.

One technique for increasing the bandwidth and the number of bands on which an antenna operates involves an antenna element included in an antenna apparatus being provided with a folded portion, and the tip of the folded portion having a capacitive coupling portion. Japanese Laid-Open Patent Publication No. 2009-111999 discloses a configuration in which an antenna, obtained by forming a radial line connected at one end to a feed portion and having an open end at the other end into a loop line having a folded portion midway, is provided with a capacitive coupling portion in which portions of the line are arranged opposite each other via a dielectric.

However, in the configuration disclosed in the above patent publication, the capacitive coupling portion is formed by a three-dimensional structure using metal elements, which increases the likelihood of variation arising due to the mass production and assembly involved in attaching the metal elements, and means that the antenna itself will be enlarged as a result of its height being increased by the thickness constituting the capacitive coupling portion.

### SUMMARY OF THE INVENTION

An antenna apparatus disclosed by the present application includes a substrate, a ground plane formed on an arbitrary surface of the substrate and serving as ground potential, a first antenna element formed on an arbitrary surface of the substrate, a feed portion supplying power to the first antenna element, a second antenna element formed on a different surface of the substrate from the surface on which the first antenna element is formed, a first ground element extending from the ground plane, a first interlayer connecting portion formed so as to pass through the substrate and electrically connecting the first antenna element and the second antenna element, a first capacitive coupling portion where the first antenna element and the second antenna element overlap or are in proximity to each other across the substrate and are capacitively coupled, and a loop configuration electrically constituted by the first antenna element, the second antenna element, the first interlayer connecting portion and the first capacitive coupling portion, with the first antenna element, the second antenna element, the ground plane and the first ground element each being formed on an arbitrary surface of the substrate by a conductive pattern.

According to the disclosure of the present application, antenna elements can be designed with only a common dielectric substrate, thereby allowing for a configuration that suppresses variation in the capacitance value and is highly convenient in terms of mass production and mounting, and enabling both miniaturization of the antenna apparatus and an increase in the bandwidth available for transmitting and receiving wireless signals.

### BRIEF DESCRIPTION OF THE DRAWINGS

FIG. 1 is a perspective view of an antenna apparatus according to an embodiment.

FIG. 2 is a plan view of the antenna apparatus according to the embodiment.

FIG. 3 is a cross-sectional view of a Z-Z portion in FIG. 2.

FIG. 4 is a cross-sectional view of the antenna apparatus provided with a protective material.

FIG. 5 is a cross-sectional view of the antenna apparatus fixed to a metal casing.

FIG. 6 is a perspective view showing a variation of the antenna apparatus.

FIG. 7 is a perspective view of a composite substrate provided with the antenna apparatus.

FIG. 8A is a schematic diagram of an antenna apparatus of Example 1.

FIG. 8B is a characteristics diagram showing the frequency characteristics of the antenna apparatus of Example 1.

FIG. 9A is a schematic diagram of the antenna apparatus of Example 1.

FIG. 9B is a characteristics diagram showing the frequency characteristics of the antenna apparatus of Example 1.

FIG. 10A is a perspective view of an antenna apparatus of Example 2.

FIG. 10B is a plan view of first through-holes in the antenna apparatus of Example 2.

FIG. 11A is a schematic diagram of the antenna apparatus of Example 2.

FIG. 11B is a characteristics diagram showing the frequency characteristics of the antenna apparatus of Example 2.

FIG. 12A is a perspective view of an antenna apparatus of Example 4.

FIG. 12B is a characteristics diagram showing the frequency characteristics of the antenna apparatus of Example 4.

FIG. 13A is a schematic diagram of the antenna apparatus of Example 4.

FIG. 13B is a characteristics diagram showing the frequency characteristics of the antenna apparatus of Example 4.

FIG. 14A is a perspective view of an antenna apparatus of Example 5.

FIG. 14B is a cross-sectional view of a Z-Z portion in FIG. 14A.

FIG. 14C is a characteristics diagram showing the frequency characteristics of the antenna apparatus of Example 5.

FIG. 15A is a perspective view of an antenna apparatus of Example 6.

FIG. 15B is a characteristics diagram showing the frequency characteristics of the antenna apparatus of Example 6.

FIG. 16 is a perspective view showing a variation of the antenna apparatus of Example 6.

FIG. 17A is a perspective view of an antenna apparatus of Example 7.

FIG. 17B is a characteristics diagram showing the frequency characteristics of the antenna apparatus of Example 7.

FIG. 18A is a perspective view of an antenna apparatus of Example 3.

FIG. 18B is a characteristics diagram showing the frequency characteristics of the antenna apparatus of Example 3.

FIG. 19 is a plan view of an antenna apparatus of Example 8.

FIG. 20 is a plan view of an antenna apparatus of Example 9.

### DETAILED DESCRIPTION OF THE INVENTION

### Embodiments

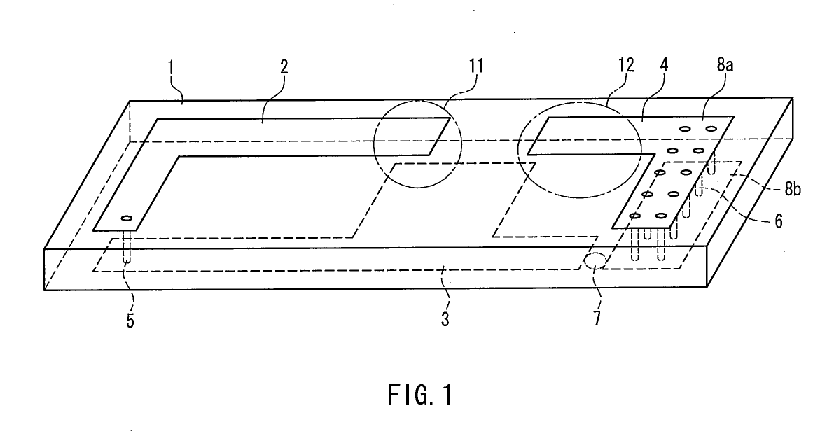

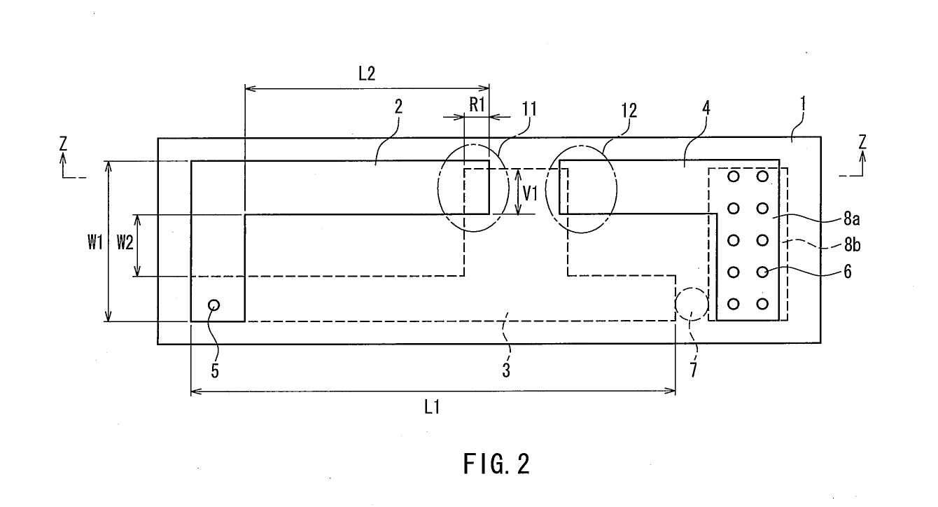

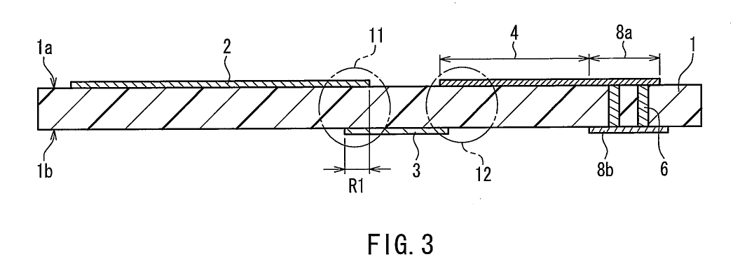

FIG. 1 is a perspective view of an antenna apparatus according to the present embodiment. FIG. 2 is a plan view of the antenna apparatus shown in FIG. 1. FIG. 3 is a cross-sectional view of a Z-Z portion in FIG. 2. Hereinafter, the basic configuration of the antenna apparatus of the present embodiment will be described.

As shown in FIG. 1, the antenna apparatus of the present embodiment is provided with a substrate 1, a first antenna element 3, a second antenna element 2, a first ground element 4, a first through-hole 5, second through-holes 6, a feed portion 7, a first ground plane 8a, a second ground plane 8b, and a capacitive coupling portion 11. The substrate 1 is constituted by an approximately plate-like dielectric substrate. A common circuit board including an insulator (glass epoxy board, composite board, halogen free board, a polytetrafluoroethylene resin board, etc.) with a fixed dielectric constant can be used for the substrate 1. A typical FR4 board has a relative dielectric constant of 4.5 to 5.0 (1 MHz) and a dielectric loss tangent of about 0.02. The substrate 1 has wiring surfaces enabling conductors to be patterned on at least two surfaces. A feature of the substrate 1 is that a higher dielectric constant results in a larger wavelength shortening effect and enables greater miniaturization of the antenna, but narrows the bandwidth. However, since the substrate 1 can be constituted using a common substrate, an optimal combination of substrate thickness and dielectric constant that is compatible both with miniaturization and with an increase in bandwidth can be selected readily. The substrate 1 can be constituted by a double-sided board, a multilayer board, a buildup board, or the like having at least two wiring surfaces with a substrate thickness (e.g., at least 0.1 mm) (greater than the order of 10⁻¹ mm) tailored to the application. Also, in the case of a multilayer board, the substrate 1 is able to obtain similar effects to the present embodiment by selecting two arbitrary layers and arranging the antenna elements and the like according to the present embodiment thereon. Also, the substrate 1 may be covered by a protective agent such as solder resist.

The first antenna element 3 is a conductive pattern formed on a second surface 1b of the substrate 1. The second antenna element 2 is a conductive pattern formed on a first surface 1a of the substrate 1. The first antenna element 3 and the second antenna element 2 partially oppose (overlap or are in proximity to) each other across the substrate 1. The first antenna element 3 and the second antenna element 2 are electrically connected via the first through-hole 5. The first antenna element 3 and the second antenna element 2 can be formed by a conductor such as gold (Au) or copper (Cu), for example.

The first ground element 4 is a conductive pattern formed on the first surface 1a of the substrate 1. The first ground element 4 is integrally formed with the first ground plane 8a or the second ground plane 8b. The first ground element 4 can be formed by a conductor such as gold (Au) or copper (Cu), for example.

The first through-hole 5 and the second through-holes 6 each consists of a hole that is formed so as to pass through the substrate 1 from the first surface 1a to the second surface 1b, and a conductor portion formed inside the hole. The conductor portion can be applied by plating gold (Au) or copper (Cu) on the wall surface of the hole. The first through-hole 5 is provided in order to constitute the capacitive coupling portion 11 by arranging the first antenna element 3 and the second antenna element 2 on different layers of the substrate, and the position thereof is not limited. Although a single first through-hole 5 is formed in the present embodiment as shown in FIGS. 1 and 2, there may be more than one. The second through-holes 6 are not limited to the number shown in FIGS. 1 and 2 in the present embodiment. Note that the first through-hole 5 and the second through-holes 6 can each be constituted by a blind via or a buried via as an IVH (Interstitial Via Hole) connecting only target layers, in the case where the substrate 1 is constituted by a multilayer board. Also, in the present embodiment, the diameter of the first through-hole 5 and second through-holes 6 is set at 0.4 mm.

The feed portion 7 supplies current to the second antenna element 2. Coaxial cable, for example, can be used for the power supply to the feed portion 7.

The first ground plane 8a is a ground potential conductive pattern formed on the first surface 1a of the substrate 1. The first ground plane 8a is formed integrally with the first ground element 4 formed by a conductive pattern. That is, the first ground plane 8a and the first ground element 4 are formed by a single conductive pattern. The second ground plane 8b is a ground potential conductive pattern formed on the second surface 1b of the substrate 1. The first ground plane 8a and the second ground plane 8b opposes each other across the substrate 1, and are electrically connected via the plurality of second through-holes 6 so as operate as a common GND at a desired frequency. Note that in the present embodiment, although the first ground element 4 is formed by a single conductive pattern with the first ground plane 8a, the first ground element 4 may be formed integrally with the second ground plane 8b having give same potential.

As shown in FIGS. 2 and 3, the first capacitive coupling portion 11 is formed by the first antenna element 3 and the second antenna element 2. The first capacitive coupling portion 11 is formed by a portion of the first antenna element 3 and a portion of the second antenna element 2 overlapping in the thickness direction of the substrate 1 and being capacitively coupled. Note that with the first capacitive coupling portion 11, a portion of the first antenna element 3 and a portion of the second antenna element 2 do not necessarily need to completely overlap in the thickness direction of the substrate 1, and the first capacitive coupling portion 11 in the present embodiment can be formed, even if a portion of the first antenna element 3 and a portion of the second antenna element 2 only are close enough to be affected by the electromagnetic field of the high frequency region, such as where the first antenna element 3 is arranged in a position slightly removed from the parallel plane of the second antenna element 2, for example.

Note that in the present specification, the state in which the first antenna element 3 and the second antenna element 2 overlap across the substrate 1 will be referred to as “overlapping.” Also, in the present specification, the state where the first antenna element 3 and the second antenna element 2 are capacitively coupled at high frequency without overlapping will basically be referred to as being “in proximity” but may also be referred to as “overlapping.” That is, “overlapping” in the present specification is taken in a broad sense to include the state where the first antenna element 3 and the second antenna element 2 do not overlap. The above definition of “overlapping” also applies to elements other than antenna elements.

The antenna apparatus of the present embodiment thus realizes a loop configuration electrically constituted by the first antenna element 3, the second antenna element 2, the first through-hole 5 and the first capacitive coupling portion 11, as a result of being provided with the first through-hole 5 and the first capacitive coupling portion 11.

Note that the antenna can be impedance matched by adjusting a first overlapping length R1 or the area of the overlapping region of the first antenna element 3 and the second antenna element 2 in the capacitive coupling portion 11. The size of the capacitance value of the first capacitive coupling portion 11 can be adjusted in a range of a few tens of pF, by adjusting the first overlapping length R1 or the area of the overlapping region (overlapping length R1×overlapping width V1 shown in FIG. 2) of the first antenna element 3 and the second antenna element 2 in the capacitive coupling portion 11.

The antenna apparatus of the present embodiment can be realized at low cost, since the antenna can be formed with only the substrate 1 and conductive patterns, without needing additional elements such as sheet metal.

Also, the profile and size of the antenna apparatus can be reduced, since only the conductive patterns are formed on the first surface 1a and the second surface 1b, and there are no members that projected significantly from the plane of the substrate 1. Reducing the profile and size of the antenna apparatus enables a communication module or an electronic device provided with the antenna apparatus to be miniaturized.

Also, since the antenna can be impedance matched by adjusting the overlapping length R1 of the first capacitive coupling portion 11, the antenna apparatus of the present embodiment can be realized at low cost, without needing matching circuit components such as a chip constant circuit.

Also, the bandwidth of the antenna apparatus can be increased by adjusting both the capacitance component resulting from the overlapping region of the first antenna element 3 and the second antenna element 2, and also adjusting the inductor component of the antenna elements by effectively arranging the first through-holes 5 through designating the number and positions thereof. Note that the relation between the arrangement of the first through-holes 5 and increasing the bandwidth of the antenna apparatus will be mentioned later based on examples.

Also, the present embodiment allows the antenna impedance to be controlled by incorporating an adjustable capacitance component and inductor component in the antenna elements, and is effective in designing and realizing multi-band and wideband antennas.

Power to the first antenna element 3 and the second antenna element 2 can be supplied directly from a high frequency circuit constituted on the same substrate by the wiring of a high frequency line such as a micro-strip line using the first ground plane 8a and the second ground plane 8b. By adopting such a configuration, the antenna elements and the high frequency circuit of a wireless apparatus can be integrally formed on the same substrate, and workability at the time of mounting can be improved, at the same time as enabling miniaturization of the antenna apparatus and the communication module.

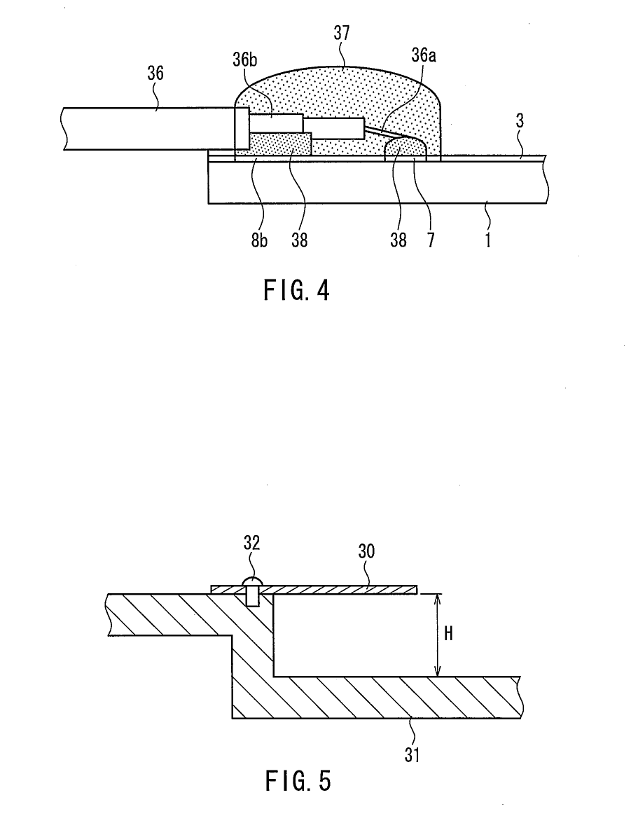

Note that an external feed line such as coaxial cable can be used for the power supply to the antenna apparatus. FIG. 4 is a side view of the antenna apparatus to which coaxial cable is connected as the feed line. Note that, in FIG. 4, only a protective material 37 and solder 38 are dot-hatched, in order to clearly illustrate each configuration. As shown in FIG. 4, a core wire 36a of a coaxial cable 36 is electrically connected with the solder 38 to the second ground plane 8b formed on the substrate 1. Also, a mesh copper wire 36b of the coaxial cable 36 is electrically connected with the solder 38 to the feed portion 7 formed in the substrate 1. The coaxial cable 36 thereby can be mechanically fixed to the antenna apparatus as well as being electrically connected thereto. Also, as shown in FIG. 4, covering the feed portion 7 with a protective material 37 enables the attachment strength of the coaxial cable 36 to the antenna apparatus to be improved, as well as enabling the feed portion to be constituted in a non-conductive state. All front ends of the wireless portion can thereby be designed in a non-conductive state by combining this configuration with the substrate antenna elements covered by solder resist, enabling a fully waterproof structure that allows the antenna portion to also withstand exposure to water to be realized. Note that the protective material 37 can be formed with materials such as resin, an adhesive and a waterproof sheet.

Also, the substrate 1 can be mechanically fixed to the casing or the like of an electronic device by screw coupling, spring pressure support, or the like. In the case where the substrate 1 is fixed to a metal casing by screw coupling, the first ground plane 8a and the second ground plane 8b of the substrate 1 can be electrically connected to the metal casing, as a result of the first ground plane 8a or the second ground plane 8b being arranged in a position contacting the metal casing surface and screwed to the metal casing of the electronic device.

FIG. 5 is a cross-sectional view showing an example in the state where an antenna apparatus 30 is fixed to the metal casing 31 with a screw 32. With the antenna apparatus 30, it is preferable, in terms of the transmission and reception characteristics of the antenna, for at least the portion on which the antenna elements are arranged to be separated from the metal casing 31, as shown in FIG. 5. With the configuration shown in FIG. 5, a gap H can be formed between the antenna apparatus 30 and the metal casing 31 by fixing the antenna apparatus 30 to a stepped portion of the metal casing 31. Sufficient tolerance can thus be obtained to vibration, heat and the like that are applied to the metal casing 31, by screw coupling the antenna apparatus 30 to the metal casing 31 with the screw 32.

In the case where the substrate 1 is fixed to the metal casing by spring pressure support, the first ground plane 8a and the second ground plane 8b can be electrically connected to the metal casing, by forming a spring of a conductor such as metal, fixing the spring to the metal casing, and pressing the spring against the first ground plane 8a or the second ground plane 8b in an elastically deformed state.

Note that in the case of forming the casing of an electronic device with resin, it is preferable to arrange a conductive sheet or the like having a constant area (about ¼λ or greater per side) relative to the desired frequency in the casing, and to electrically connect the first ground plane 8a or the second ground plane 8b to the conductive sheet using the above screw coupling or spring pressure support. By adopting such a configuration, the antenna apparatus can be reliably electrically grounded, and transmission and reception characteristics equivalent to the case where the substrate is fixed to the metal casing can be obtained.

Also, the antenna apparatus can be integrally formed with a communication module or a main substrate of an on-board wireless device, and the first ground plane 8a or the second ground plane 8b provided in the antenna apparatus also can be shared with a ground plane formed on the main substrate or the like.

Also, the first ground element 4 may be wired in parallel with the first antenna element 3 in an approximately linear state, and a notched or meander line structure may be used midway for adjusting the electrical length or impedance.

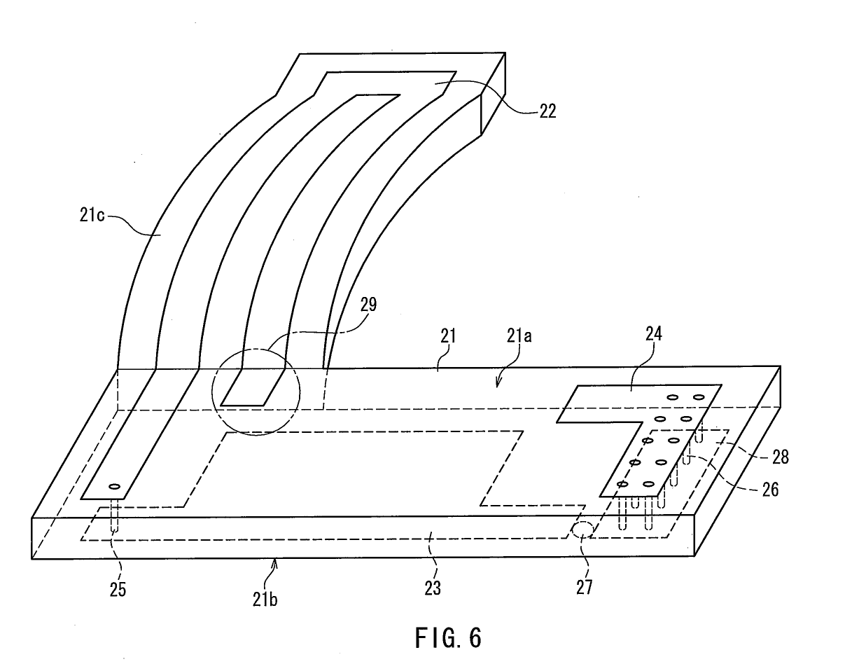

Also, although the substrate 1 is approximately plate-like in the present embodiment, other shapes may be adopted. FIG. 6 is a perspective view of an antenna apparatus that is partially curved. There is a high degree of design flexibility with the shape of the antenna apparatus, and equivalent performance to the rectangular substrate can be obtained even with a substrate that is bent or curved depending on the attachment space and mechanism conditions. The antenna apparatus shown in FIG. 6 is provided with a curved portion 21c on a portion of a substrate 21. A first antenna element 22 is formed on the curved portion 21c. A second antenna element 23 is formed on a second surface 21b of the substrate 21. A ground element 24 is formed on a first surface 21a of the substrate 21. Through-holes 25 and 26 are constituted by forming a conductive pattern on the inside of holes formed so as to pass through from the first surface 21a to the second surface 21b of the substrate 21. The through-hole 25 electrically connects the first antenna element 32 and the second antenna element 23. The through-holes 26 electrically connect the ground element 24 and a ground plane 28. A feed portion 27 supplies current to the second antenna element 23. A capacitive coupling portion 29 is a portion where the first antenna element 32 and the second antenna element 23 oppose each other across of the substrate 21. The first antenna element 32 and the second antenna element 23 are capacitively coupled in the capacitive coupling portion 29.

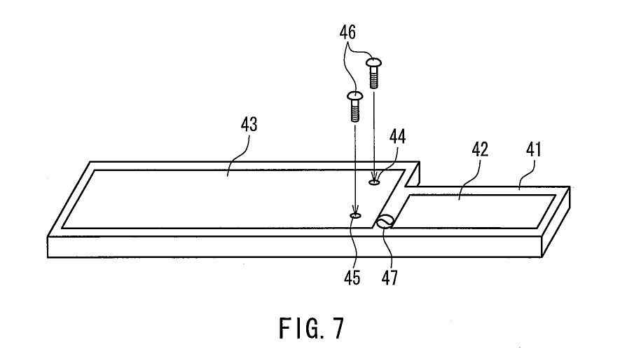

Also, although the present embodiment has been described with regards to an antenna apparatus that functions as an antenna, antenna elements and other circuits may be mounted on a single substrate. FIG. 7 is a perspective view of a substrate provided with antenna element and circuit portions. A substrate 41 shown in FIG. 7 is provided with an antenna element portion 42, a circuit portion 43, a feed portion 47, and hole portions 44 and 45. The antenna element portion 42 is provided with a first antenna element 3, a second antenna element 2, and the like, such as shown in FIG. 1, for example. The circuit portion 43 is electrically connected to the antenna element portion 42. The circuit portion 43 is provided with a transmission circuit and a reception circuit, for example. The hole portions 44 and 45 are capable of accepting screws 46 inserted therethrough. The screws 46 are able to fix the substrate 41 to a casing by being inserted through the hole portions 44 and 45 and screwed into screw holes formed in the casing (not shown) or the like. The number of components can be reduced and cost cutting can be achieved, by providing the antenna element portion 42 and the circuit portion 43 on a single substrate 41, as shown in FIG. 7. Manufacturing of the substrate will also be facilitated. In the configuration shown in FIG. 7, the substrate 41 can be easily grounded, by electrically connecting a ground plane (e.g., first ground plane 8a shown in FIG. 1) of the antenna element portion 42 or a ground plane (not shown) of the circuit portion 43, and fixing at least one of the ground planes to a metal casing (e.g., see FIG. 6) so as to contact the metal casing.

Also, since a first resonance frequency of the antenna apparatus is dependent on a total element length L1 and an element width W1 (see FIG. 2) combining the first antenna element 3 and the second antenna element 2, the first resonance frequency can be controlled by adjusting the total element length L1 and the element width W1. A second resonance frequency can be controlled mainly by adjusting a length dimension L2 and a width dimension W2 (see FIG. 2) of an electrically constituted loop configuration portion (first antenna element 3, second antenna element 2, first through-hole 5, first capacitive coupling portion 11), and the capacitance value of the first capacitive coupling portion 11.

Also, adjusting the capacitance value of the first capacitive coupling portion 11 (C component) and the inductance value of the first antenna element 3 and the second antenna element 2 (L component) enables the voltage standing wave ratio (VSWR) of a desired frequency to be adjusted, even in the case where the antenna apparatus is not equipped with a matching circuit that uses a lumped constant circuit such as a ceramic condenser. Note that the relationship between the capacitance value, the inductance value, and VSWR will be mentioned later.

Also, a second resonance can be obtained, even if the width dimension W2 of the electrically constituted loop configuration portion (first antenna element 3, second antenna element 2, first through-hole 5, first capacitive coupling portion 11) is as small as about 0.5 mm (2.5×10⁻³λ of second resonance frequency).

At this time, the main structure of the loop configuration portion is consists of a combination of the first capacitive coupling portion 11 and the second antenna element 2 or the folded shape of the antenna element end constituted by combining the second antenna element 2, the first antenna element 3, and the through-hole 5.

Also, impedance mainly including the first resonance and the third resonance also can be adjusted using the capacitance value of a second capacitive coupling portion 12, in addition to the total element length and element width of the first antenna element 3 and the first ground element 4. The capacitive coupling portion 12 is not limited to being constituted by a portion near the antenna power supply point in the diagram, and may be partially provided on a portion of the first antenna element or the second antenna element depending on the length and arrangement of the ground element.

The above impedance including the first resonance and third resonance can be adjusted independently of impedance including the second resonance, and impedance matching in multiple desired bands can be realized. Note that the impedance adjustment method will be mentioned later.

In the present embodiment, the electrical length of the first resonance region can be increased by adopting a shape in which the substrate end side is folded as shown in FIG. 1 and FIG. 2. That is, the element length L1 (see FIG. 2) can be shortened, as compared with a configuration in which the first antenna element 3 is not folded. Also, since the first resonance bandwidth is little affected even when the second resonance frequency is added as a result of the antenna apparatus being equipped with an electrically constituted loop configuration, both multi-band characteristics and wideband characteristics can be obtained. Note that the relationship between the folded shape of the tip of an antenna element forming the loop configuration and the frequency band will be mentioned later.

Also, although a laptop personal computer was mentioned as an electronic device provided with the antenna apparatus in the present embodiment, the present invention is applicable to any electronic device that is at least capable of wireless communication. Examples of such an electronic device include a mobile phone terminal, a home video game machine, and a PDA (Personal Digital Assistant).

Hereinafter, examples of the antenna apparatus according to the present embodiment will be described.

### Example 1

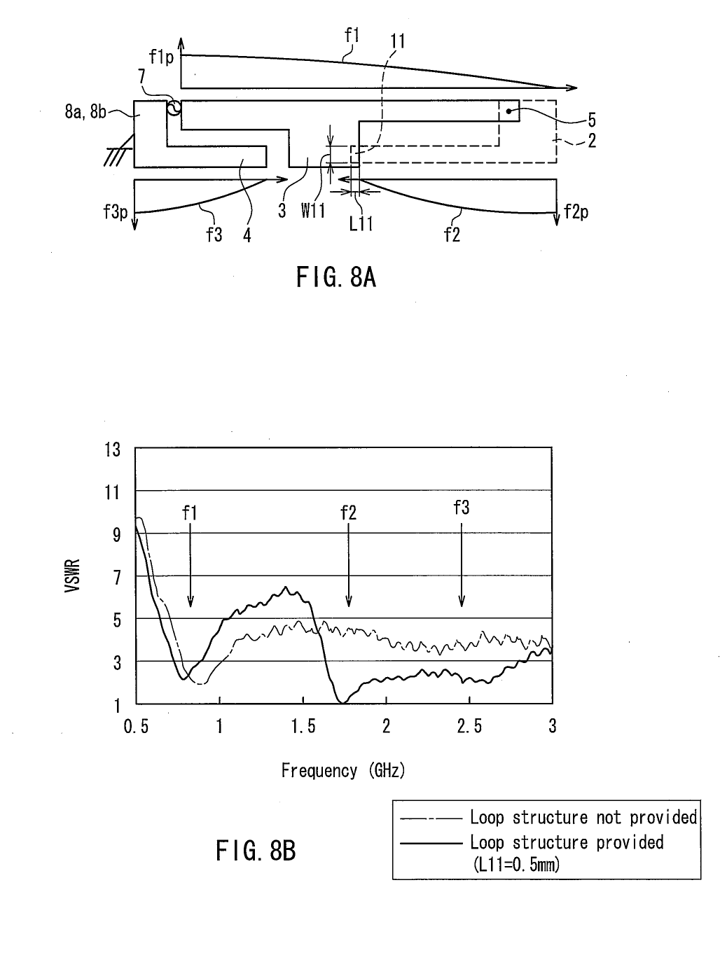

FIG. 8A is a schematic diagram of an antenna apparatus according to Example 1. FIG. 8B is a characteristics diagram showing the frequency characteristics of an antenna apparatus according to Example 1, in the case where an electrically constituted loop configuration is provided and in the case where a loop configuration is not provided. Hereinafter, typical features will be shown using the antenna configurations and evaluation results.

Note that in FIG. 8A, the same reference numerals are given to constituent elements that are similar to the constituent elements of the antenna apparatus shown in FIG. 1 or the like, and a detailed description thereof will be omitted. In FIG. 8A, a reference numeral f1 denotes the distribution of current flowing in the long-side direction of a first antenna element 3 and a second antenna element 2. A reference numeral f2 denotes the distribution of current flowing in the long-side direction of the first antenna element 3. A reference numeral f3 indicates the distribution of current flowing in the long-side direction of the first ground element 4.

A FR4 double-sided board having approximate substrate dimensions L×W×D=71.0×7.0×0.8 (unit: mm) and approximate element dimensions L×W×D=51.0×6.0×0.8 (unit: mm) was used for the antenna apparatus according to Example 1. The laptop personal computer covered with a metal casing (e.g., a casing at least partially formed with magnesium) was used for the device equipped with the antenna apparatus. The antenna apparatus was fixed by a pin such that a first ground plane 8a or a second ground plane 8b contacts a portion of the metal casing. The antenna apparatus was fixed in a state such as shown in FIG. 5, for example, and the interval (height H shown in FIG. 5) between the antenna apparatus and the metal casing was approximately 9 mm.

The first antenna element 3 and the second antenna element 2 are electrically connected via a first through-hole 5 near an end portion of the antenna apparatus. Also, the first antenna element 3 opposes the second antenna element 2 across the insulator (relative dielectric constant ∈0≈4) of the FR4 board at a longitudinal edge (first capacitive coupling portion 11). A length dimension L11 and a width dimension W11 of the region where the first antenna element 3 and the second antenna element 2 overlap in the first capacitive coupling portion 11 were set to 0.5 mm and 3.0 mm, respectively.

The antenna apparatus having the above configuration was connected via coaxial cable, and the reflection characteristics were evaluated, the results of which are shown in FIG. 8B. As shown in FIG. 8B, the antenna apparatus in Example 1 consists of three operating modes: a first resonance frequency f1 (800 MHz band) at which the antenna apparatus resonates along its entire length, a second resonance frequency f2 (1.8 GHz band) at which the electrically constituted loop configuration resonates, and a third resonance frequency f3 (2.3 GHz band) at which the first ground element 4 resonates. Resonance resulting from the second resonance frequency f2 and the third resonance frequency f3 can be set in adjacent frequencies, and an increase in bandwidth can be achieved using the double-resonance characteristics.

The change of characteristics due to the reflection characteristics (voltage standing wave ratio (VSWR)) is shown using FIG. 8B. In the case where the first capacitive coupling portion 11 and the folded shape of the antenna element end constituting a loop configuration are not provided, not only is there no resonance frequency f2 resulting from a loop configuration but the impedance characteristics of the resonance frequency f3 resulting from the first ground element cannot be adequately matched, creating a problem in the high-band (2 GHz band). In contrast, in the case where a loop configuration is provided, not only is the frequency f2 added due to the resonance resulting from the loop configuration but matching of the resonance frequency f3 is improved in combination with the loop configuration, enabling wideband antenna characteristics to be realized in the high-band. This effect is due to combining the first ground element having the third resonance frequency f3 resulting from series resonance whose antenna. Q value (quality factor) is comparatively low and the loop configuration having the second resonance frequency f2 resulting from parallel resonance whose antenna. Q value is comparatively high.

At this time, as with the current waveform shown in FIG. 8A, the antenna apparatus operates with the peaks (f2p, f3p) in the current distribution of the second resonance frequency f2 and the third resonance frequency f3 positioned away from each other at either end of the antenna apparatus, and has features that make it unlikely that the reflection characteristics will deteriorate (that antiresonance will occur) between the respective frequencies of the adjacent first resonance frequency f1 and second resonance frequency f2. An increase in bandwidth to between the second and third resonance frequencies (f3-f2) can thereby be achieved.

These features enable wideband antenna matching to be secured within the antenna apparatus, without using a matching circuit such as a chip constant circuit. Note that although a matching circuit such as a chip constant circuit is not required in the present example, antenna matching can be performed even if a matching circuit is provided.

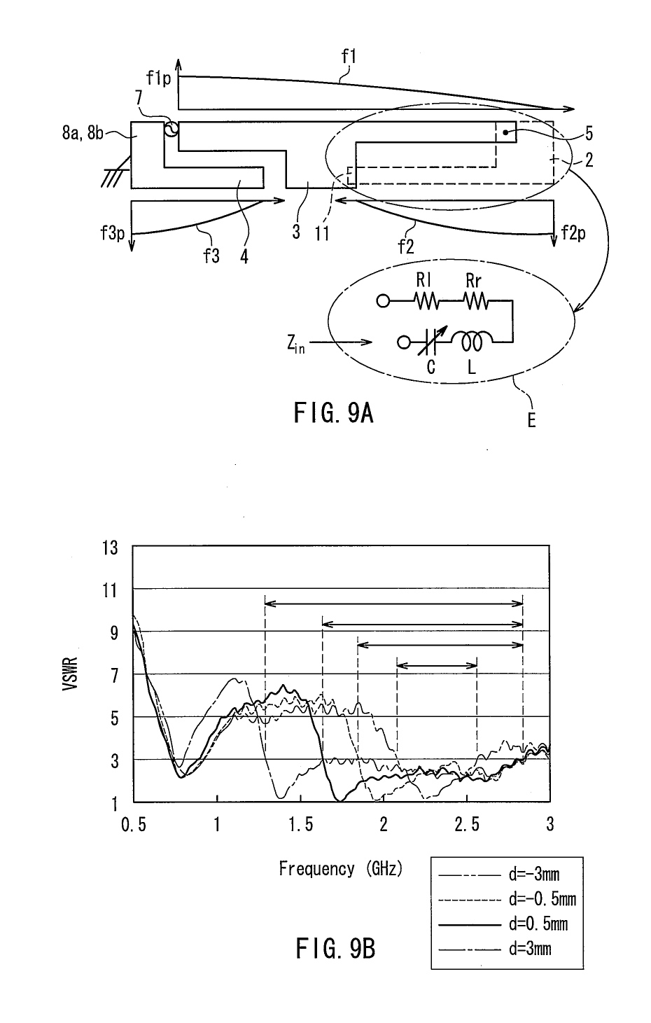

FIG. 9A shows an equivalent circuit of the loop configuration of the antenna apparatus according to Example 1. FIG. 9B is a characteristics diagram showing the frequency characteristics in the case where the overlapping length of the first antenna element 3 and the second antenna element 2 in the first capacitive coupling portion 11 was changed, and the features will be shown using these frequency characteristics.

A circuit diagram E is an equivalent circuit in the loop configuration portion that is constituted by the first antenna element 3, the second antenna element 2, the first through-hole 5 and the first capacitive coupling portion 11, and controls the second resonance frequency.

FIG. 9B shows the frequency characteristics when the overlapping length d in the first capacitive coupling portion 11 was set to −3.0 mm, −0.5 mm, +0.5 mm, and +3.0 mm. The plus sign of the above overlapping lengths d indicates the case where the first antenna element 3 and the second antenna element 2 overlap. The minus sign of the above overlapping lengths d indicates the case where the first antenna element 3 and the second antenna element 2 do not overlap.

As shown in FIG. 9B, in the case where the overlapping length d of the first capacitive coupling portion 11 is −3 mm (i.e., state in which the antenna elements do not overlap), only one resonance that mainly operates at the third resonance frequency f3 is visible, and the fractional bandwidth thereof is 21% of the center frequency 2.3 GHz (VSWR<3). In contrast, in the case where the overlapping length d is set to −0.5 mm, 0.5 mm or 3 mm where there is a capacitance value between the elements, the second resonance frequency f2 becomes evident and, when combined with the third resonance frequency f3, allows the fractional bandwidth of the high-band to expand to 42%, 53% and 76% (VSWR<3) with movement of the resonance frequency f2 following a change in the capacitance value of the capacitive coupling portion 11. An increase in bandwidth is thus realized due to the reflection characteristics between the two resonance frequencies not readily deteriorating.

The circuit diagram E in FIG. 9A illustrates an antenna equivalent circuit that is constituted by a capacitance value (C) of the capacitive coupling portion 11, an inductance value (L) of the folded shape, a radiation resistance (Rr) and a loss resistance (R1), and controls an input impedance (Zᵢₙ) of the second parallel resonance frequency f2.

Here, the resonance frequency f2 resulting from the loop configuration can be adjusted lower by controlling the capacitance value (C) in the first capacitive coupling portion 11. The antenna apparatus is, therefore, able to respond to low frequencies by adjusting the capacitance value without expanding the antenna space, whereas usually, in order to respond to low frequencies, the antenna elements need to be extended to secure the electrical length. Accordingly, the antenna apparatus is useful as an antenna in which wideband characteristics are obtained by performing frequency matching with the antenna element structure, and that enables space-saving design.

The second resonance frequency f2 is controlled with the capacitive coupling portion 11 and the second antenna element 2 or the folded shape (L2) of the antenna element end constituted by combining the second antenna element 2, the first antenna element 3 and the through-hole 5, and the third resonance frequency f3 is controlled in a vicinity of the first ground element 4. That is, since the second resonance frequency f2 and third resonance frequency f3 operate at portions (both ends) within the antenna apparatus that are separated from each other, antenna adjustment is facilitated since they do not readily affect each other in terms of characteristics and can be controlled independently.

These characteristics are sufficiently capable of responding to a fractional bandwidth of ≈61% (1427.9-2.690 MHz), as an example of individual frequency bands planned for allocation in wireless wide area networks (WWANs) including the upcoming LTE.

### Example 2

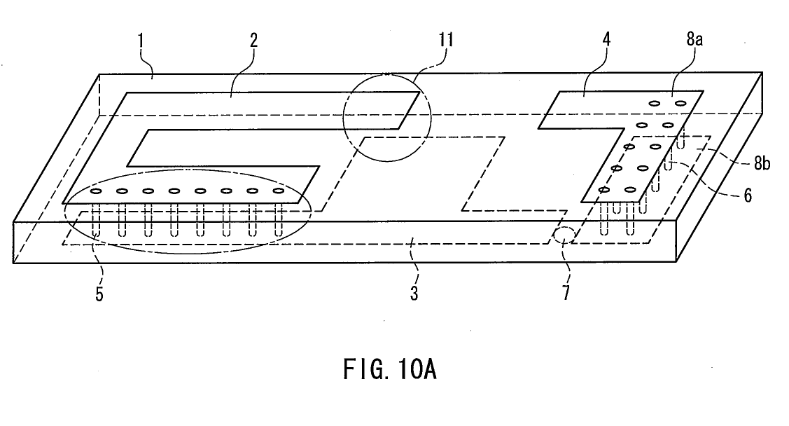

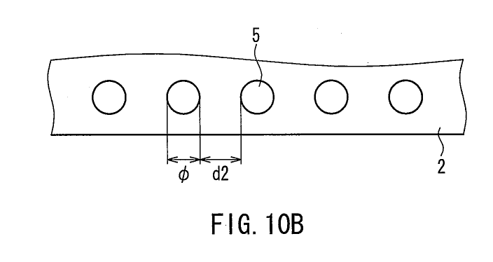

FIG. 10A is a perspective view of an antenna apparatus of Example 2. FIG. 10B is an enlarged plan view in a vicinity of through-holes in a first antenna element 3 of the antenna apparatus shown in FIG. 10A. In FIG. 10A, the same reference numerals are given to constituent elements that are similar to the constituent elements of the antenna apparatus shown in FIG. 1 or the like, and a detailed description thereof will be omitted.

In FIG. 10A and FIG. 10B, a first through-hole 5 is a hole of via diameter φ formed in the thickness direction of a substrate 1 with a conductor such as gold (Au) plated on the inner wall of the hole. A plurality of first through-holes 5 are arranged continuously along the longitudinal direction of the antenna apparatus to a region where the first antenna element 3 and a second antenna element 2 overlap. The first through-holes 5 are arranged with an edge-face spacing d2 between adjacent through-holes as shown in FIG. 10B. Although the first through-holes 5 exhibit an effect at intervals of about λ/20 relative to the first resonance frequency f1, the edge-face spacing d2 is preferably about 2 to 5 mm in the case where several GHz is targeted so that unnecessary loss or resonance does not occur with respect to the second resonance frequency f2 or the third resonance frequency f3. Note that the size of the edge-face spacing d2 is by way of example, and a similar effect to the present example is obtained even with a size that deviates from the numerical range of 2 to 5 mm.

The first through-holes 5 are preferably arranged in the first antenna element 3 and the second antenna element 2, toward the outer edge of the substrate 1. Note that the first through-holes 5 may be arranged near the center of the width direction in the overlapping region where the first antenna element 3 and the second antenna element 2 overlap via the dielectric substrate of the substrate 1. In the antenna apparatus, however, since the first antenna element 3 and the second antenna element 2 are three-dimensionally continuous in terms of high-frequency characteristics in a vicinity of the first through-holes 5, a further increase in bandwidth can be achieved by providing the first through-holes 5 near the outer edge of the substrate 1, as shown in FIG. 10A and FIG. 10B. This is because current flow from the first antenna element 3 to the second antenna element 2 through the first through-holes 5 is facilitated by arranging the first through-holes 5 continuously in an approximately linear state near the outer edge of the substrate 1 as in the present example, since the current and electric field of the first resonance frequency f1 are mainly concentrated along the edge of the first antenna element 3 from the feed portion 7 due to the skin effect of high frequency.

Also, while the first antenna element 3 and the second antenna element 2 in the overlapping region are electrically connected by the through-holes 5, a capacitance component is also provided since the antenna elements operate as a distribution constant circuit in the high frequency region, with the proportion of the capacitance component being adjustable by expanding the overlapping region. In other words, an increase in bandwidth is achieved by providing the antenna elements with a distribution constant circuit obtained by combining interlayer connection means connected to an overlapping region constituted by two opposing surfaces.

Note that the first through-holes 5 desirably include the tips of the total antenna element length portion, particularly the side of the second antenna element 2 forming part of the loop configuration or the folded shape of the antenna element end constituted by a combination of the second antenna element 2, the first antenna element 3 and the through-holes 5 that contacts the power supply point (region of the through-holes 5 in FIG. 10A).

Note that although eight first through-holes 5 are provided in the present example as shown in FIG. 10A, this number is by way of example and is not limited thereto.

Also, although the first through-holes 5 are arranged linearly along the longitudinal direction of the antenna apparatus in the present example as shown in FIG. 10A, the first through-holes 5 may be arranged in a curve or may be staggered.

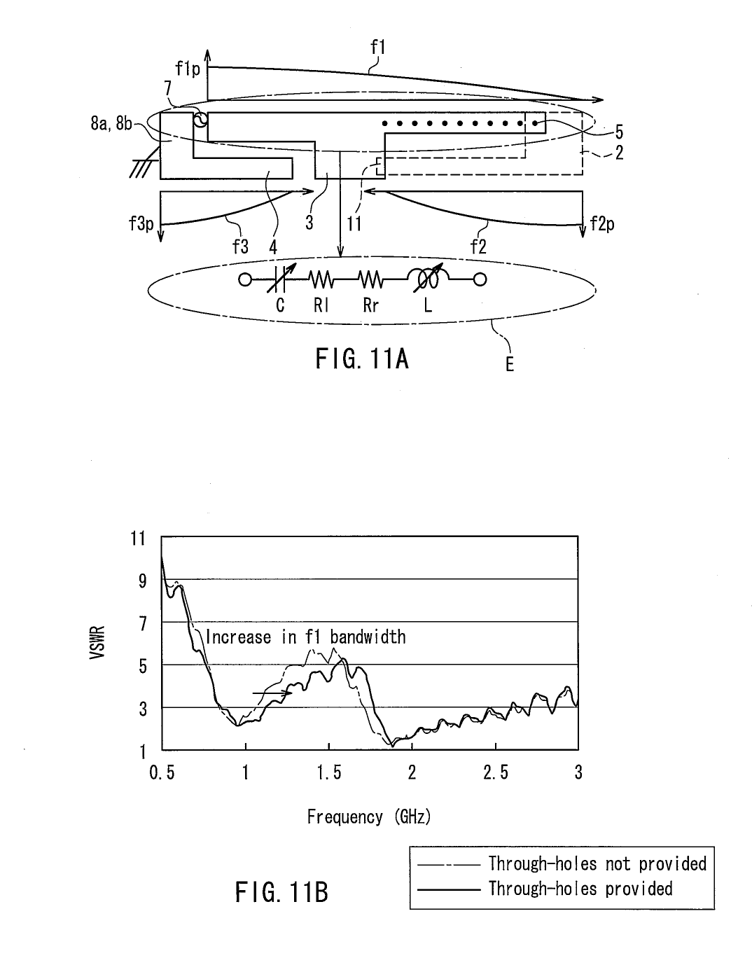

FIG. 11A is a schematic diagram of an antenna apparatus of Example 2. FIG. 11B is a characteristics diagram showing the frequency characteristics in an antenna apparatus provided with the first through-holes 5, and an antenna apparatus not provided with the first through-holes 5.

Note that in FIG. 11A, the same reference numerals are given to constituent elements that are similar to the constituent elements of the antenna apparatus shown in FIG. 1 or the like, and a detailed description thereof will be omitted. In FIG. 11A, a reference numeral f1 denotes the distribution of current flowing in the long-side direction of the first antenna element 3 and the second antenna element 2. A reference numeral f2 denotes the distribution of current flowing in the long-side direction of the first antenna element 3. A reference numeral f3 denotes the distribution of current flowing in the long-side direction of the first ground element 4. A circuit diagram E is an equivalent circuit of a total antenna element length portion that is constituted by the first antenna element 3, the second antenna element 2 and first through-holes 5, and controls a first resonance frequency.

As with the antenna apparatus of the present embodiment, the Q value of the antenna apparatus is reduced and an increase in bandwidth can be achieved, by providing a plurality of first through-holes 5 continuously.

Specifically, the Q value can be derived based on the following equation:

Q=1/Rᵢₙ×√(L/C)

The circuit diagram E in FIG. 11A illustrates an antenna equivalent circuit operating over the total antenna element length that is constituted by a capacitance (C), an inductance (L), a radiation resistance (Rr) and a loss resistance (R1), and controls an input impedance (Z1) of a first series resonance frequency f1.

Here, the capacitance (C) constituted in the antenna elements increases as a result of having a large overlapping region (area) in which the first antenna element and the second antenna element oppose each other via the dielectric substrate, in addition to the capacitance value of the capacitive coupling portion 11. Also, a cross-section of the antenna elements serving as radiating elements is constituted three-dimensionally (I-shaped, C-shaped) by using the through-holes 5 to connectively provide (at a sufficiently narrow interval relative to the first operating frequency) a plurality of overlapping regions in which the first antenna element and the second antenna element oppose each other via a dielectric, resulting in an increase in surface area and a relative decrease in the inductance (L) constituted in the antenna elements. In other words, the capacitance (C) and the inductance (L) respectively control the Q value of the antenna apparatus to be lower when substituted into the above equation for deriving the Q value, leading to an increase in antenna bandwidth.

Coaxial cable was connected to antenna apparatuses having the above configuration, and reflection evaluation was implemented. The evaluation results are as shown in FIG. 11B. As shown in FIG. 11B, the Q value can be adjusted lower by adopting a three-dimensional structure in which first through-holes 5 are provided in the antenna apparatus and that contains a dielectric, enabling the bandwidth available in the low frequency band (band including the first resonance frequency f1) to be expanded.

Note that the first through-holes 5 also can handle high frequencies by enlarging the via diameter and narrowing the via spacing. For example, setting the via diameter φ to about 0.4 mm and via spacing d2 to about 1.6 mm enables the bandwidth to be expanded in the low-band (700-900 MHz band), and desired characteristics to be obtained without a significant loss in a frequency range up to 3.0 GHz. Providing first through-holes 5 having the above dimensions enabled the fractional bandwidth to be improved from 30% to 41% (VSWR<3.5) in the low-band.

According to the present example, the low-band (fractional bandwidth ≈31%), which is the frequency band used by wireless wide area networks including the upcoming LTE, and the high-band (fractional bandwidth ≈60%) can be realized simultaneously.

Note that changing the inductance (L) resulting from the first through-holes 5 enables the bandwidth of the first resonance frequency f1 to be expanded, and the second resonance frequency f2 can be influenced by also changing the L value seen from the folded portion. In this case, the influence on the second resonance frequency f2 can be adjusted by arbitrarily adjusting the overlapping length (area of the overlapping region) of the first capacitive coupling portion 11. Therefore, the high-band and the low-band can be realized at the same time, without affecting the high-band bandwidth.

### Example 3

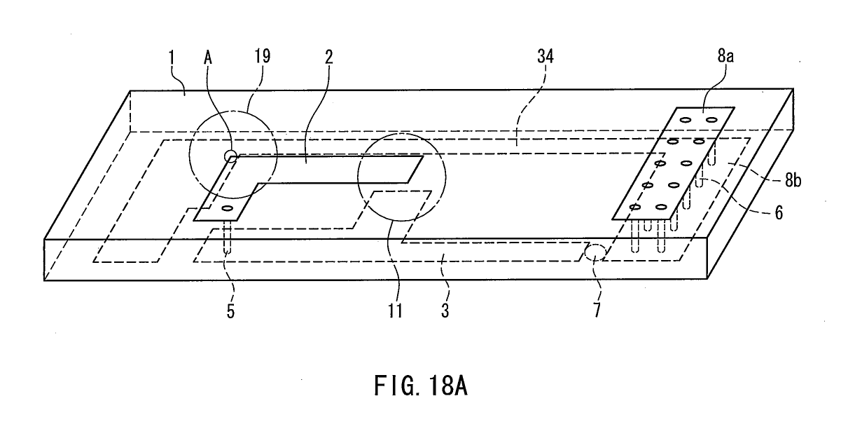

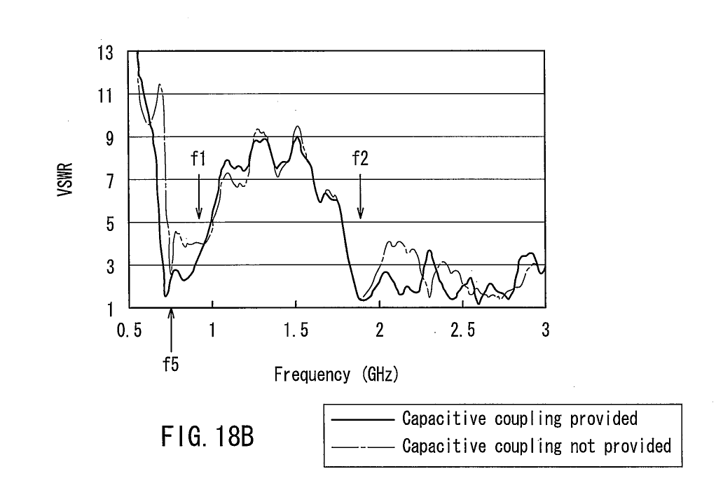

FIG. 18A is a perspective view of the antenna apparatus of Example 3. FIG. 18B is a characteristics diagram showing the frequency characteristics in the case where a branch element was provided and the case where a branch element was not provided. Note that in FIG. 18A, the same reference numerals are given to constituent elements that are similar to the constituent elements of the antenna apparatus shown in FIG. 1 or the like, and a detailed description thereof will be omitted. The antenna apparatus shown in FIG. 18A is a configuration in which the first ground element 4 in the antenna apparatus shown in FIG. 1 is extended to near the tip of the antenna apparatus.

In FIG. 18A, a third ground element 34 is formed on a second surface 1b of a substrate 1. The third ground element 34 is formed from near one end in the longitudinal direction of the substrate 1 to near the other end. One end of the third ground element 34 is formed integrally with a second ground plane 8b. The other end of the third ground element 34 overlaps a first antenna element 3 across the substrate 1, and forms a fifth capacitive coupling portion 19. The third ground element 34 and the second antenna element 2 are capacitively coupled in the fifth capacitive coupling portion 19.

Coaxial cable was connected to antenna apparatuses having the above configuration, and the reflection characteristics of the antennas were evaluated. The results were as shown in FIG. 18B. As shown in FIG. 18B, providing the fifth capacitive coupling portion 19 enables a resonance point corresponding to a fifth resonance frequency f5 to be generated adjacent to a first resonance frequency f1. Accordingly, the bandwidth can be increased in the 700 to 900 MHz band.

The ground element desirably extends from a ground plane at a fixed interval from the feed portion rather than being adjacent thereto. The connection with the ground of the third ground element 34 of the present example is configured to extend from the second ground plane 8b at a fixed interval from the feed portion 7 rather than being in proximity to or overlapping the feed portion 7. Further, since the third ground element 34 of the present example is formed to be more than 10 percent longer than the longitudinal length of the second antenna element 2, the third ground element 34 resonates at the fifth resonance frequency f5 adjacent to the first resonance frequency f1 obtained along the total length of the second antenna element 2 as shown in FIG. 18B. Accordingly, the bandwidth can be increased in the 700 to 900 MHz band as shown in FIG. 18B.

The fifth capacitive coupling portion 19 is desirably constituted by one edge of the second antenna element 2 in the longitudinal direction including a tip (A point) located at the diagonal to the power supply point, enabling the first resonance and fifth resonance impedances to be controlled using the capacitance value of the coupling portion 19.

Note that the radiation impedance of the 700 to 900 MHz band can be controlled by adjusting the area of the overlapping region and the length of adjacent sides of the fifth capacitive coupling portion 19 that are parallel with the first antenna element 3 and the third ground element 34. Generally, in the case of increasing the bandwidth in the low-band (700-900 MHz band), there is a problem in that radiation impedance tends to decreased under the influence of the metal casing or the like, resulting in a deterioration in reflection characteristics (VSWR), but the radiation impedance is increased by adjusting the area of the overlapping region of the fifth capacitive coupling portion 19, enabling an improvement in reflection characteristics and an increase in bandwidth to be realized at the same time (FIG. 18B). Also, by providing the fifth capacitive coupling portion 19, resonance transmitted through the ground element forms a loop configuration enclosed mainly by the third ground element 34 and the first antenna element 3 or the second antenna element 2. Therefore, the flow of high frequency current focused inside the loop configuration is facilitated, and operation is unlikely to be affected in the case where the third ground element 34 outside the substrate is in proximity to the casing ground as compared with an antenna element near the feed portion 7. Accordingly, the present example is also effective in miniaturizing the antenna mounting space.

Also, the first resonance frequency f1 and the fifth resonance frequency f5 can operate together without particularly affecting the second resonance frequency f2 of the loop configuration.

### Example 4

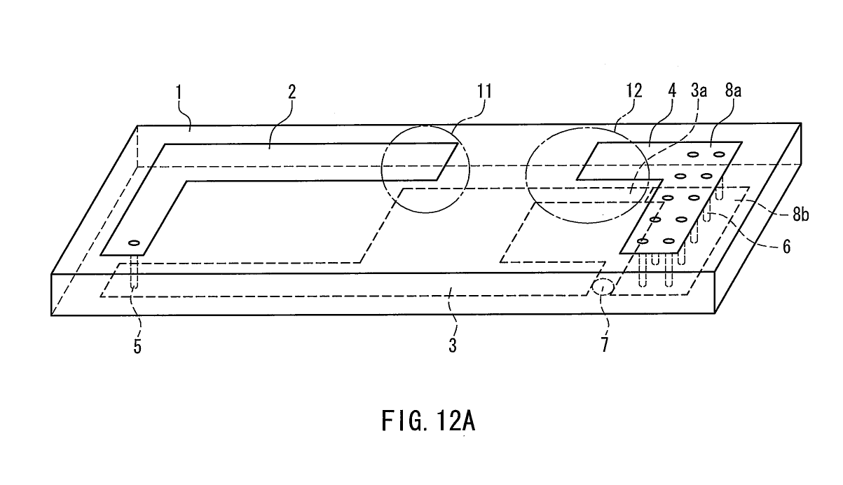

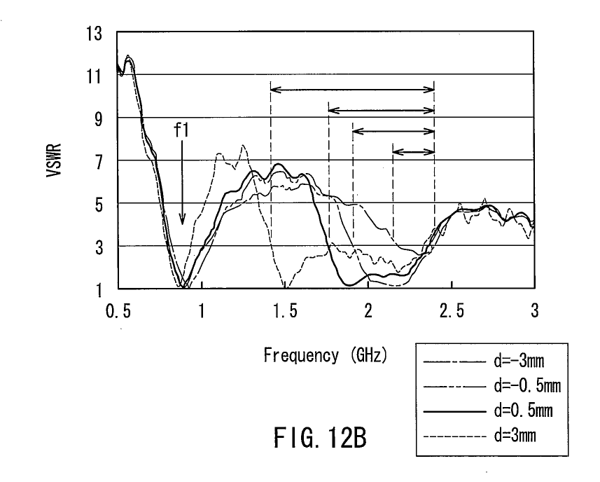

FIG. 12A is a perspective view of an antenna apparatus of Example 4. The antenna apparatus shown in FIG. 12A has an inverse F antenna structure. FIG. 12B is a characteristics diagram showing the frequency characteristics when an overlapping length d of a first capacitive coupling portion 11 of the antenna apparatus shown in FIG. 12A is set to +3 mm, +0.5 mm, −0.5 mm, and −3 mm. The plus sign in the above overlapping lengths d indicates the case where the first antenna element 3 and the second antenna element 2 overlap. The minus sign in the above overlapping lengths d indicates the case where the first antenna element 3 and the second antenna element 2 do not overlap. Note that in FIG. 12A, the same reference numerals are given to constituent elements that are similar to the constituent elements of the antenna apparatus shown in FIG. 1 or the like, and a detailed description thereof will be omitted.

The antenna apparatus shown in FIG. 12A is provided with a short circuit pin 3a in a portion of a first antenna element 3. The short circuit pin 3a electrically connects (shorts) the second antenna element 2 to a second ground plane 8b. The short circuit pin 3a overlaps a first ground element 4 across a substrate 1 (second capacitive coupling portion 12). The short circuit pin 3a and the first ground element 4 in the second capacitive coupling portion 12 are capacitively coupled. Note that the short circuit pin 3a may be partially provided with a notched or meander line structure.

Generally, a feature of an inverse F antenna structure is that the impedance is adjustable through adjustment of the length of the short circuit pin 3a, the connection position with the second antenna element 2 and the like, and a first resonance frequency f1 is readily obtained even in the case where a ground of a metal casing or the like is in proximity to an antenna element.

According to the structure of Example 5, the antenna is low profile (antenna installation height is low) as compared with a monopole antenna, and the antenna apparatus can be arranged close to the casing ground.

Coaxial cable was connected to antenna apparatuses having the above configuration, and reflection evaluation was implemented. The evaluation results are as shown in FIG. 12B. As shown in FIG. 12B, in the case where the overlapping length d in the first capacitive coupling portion 11 is −3 mm (i.e., antenna elements do not overlap), only one resonance operating mainly in a third resonance frequency f3 is visible, and the fractional bandwidth thereof is 9.6% (VSWR<3) of the center frequency 2.3 GHz. In contrast, in the case where the overlapping length d is long enough for there to be a capacitance value between the elements at −0.5 mm, 0.5 mm or 3 mm, a second resonance frequency f2 becomes evident and, when combined with the third resonance frequency f3, allows the fractional bandwidth of the high-band to expand to 22%, 29% and 49% (VSWR<3) with movement of the resonance frequency f2 following a change in the capacitance value of the capacitive coupling portion 11. An increase in bandwidth in the high-band is thus realized due to the reflection characteristics between the two resonance frequencies not readily deteriorating.

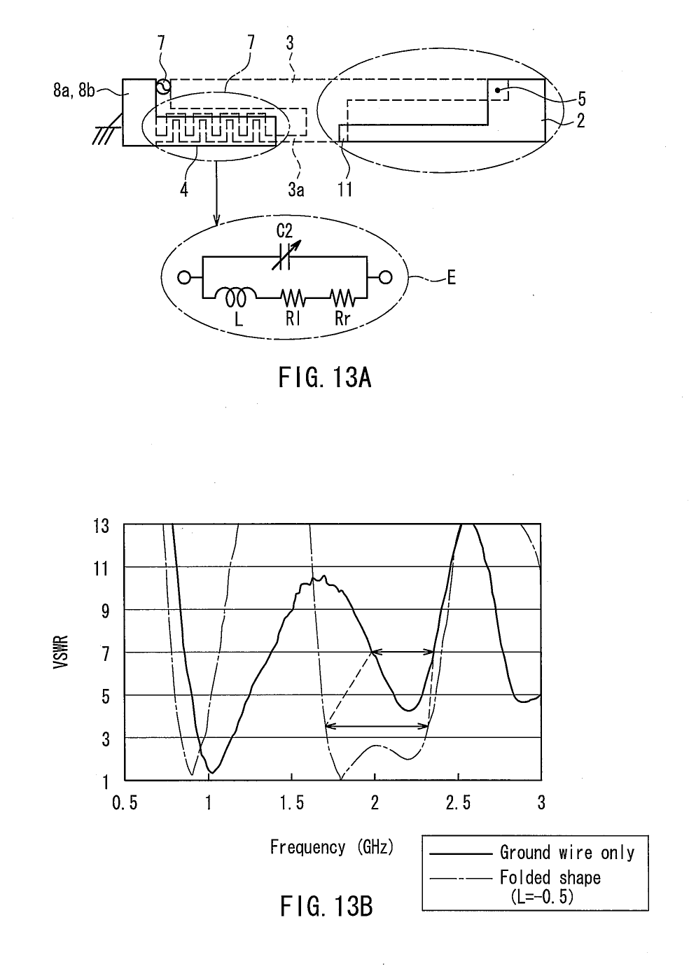

FIG. 13A is a schematic diagram of the antenna apparatus of Example 4. FIG. 13B shows the frequency characteristics in both the case where a second capacitive coupling portion 12 was provided and was not provided. Note that in FIG. 13A, the same reference numerals are given to constituent elements that are similar to the constituent elements of the antenna apparatus shown in FIG. 1 or the like, and a detailed description thereof will be omitted.

As shown in FIG. 13A, the antenna apparatus of Example 4 is provided with the short circuit pin 3a, which is folded toward the second ground plane 8b side, in the second antenna element 2. The short circuit pin 3a is electrically connected to the second ground plane 8b or formed integrally with the second ground plane 8b. The short circuit pin 3a overlaps the first ground element 4 across the substrate 1. The short circuit pin 3a and the first ground element 4 are capacitively coupled to form the second capacitive coupling portion 12. Note that although the short circuit pin 3a shown in FIG. 13A has a meander line structure, this shape is merely by way of example.

A circuit diagram E in FIG. 13A illustrates an antenna equivalent circuit that is constituted by a capacitance value (C2) of the capacitive coupling portion 12, an inductance value (L) of the first ground line 4, a radiation resistance (Rr) and a loss resistance (R1), and controls an input impedance (Zᵢₙ) of the third parallel resonance frequency f3.

The first ground element 4 operates in parallel resonance that uses the capacitance value C2 determined by the second capacitive coupling portion 12 formed between the first ground element 4 and the short circuit pin 3a or the second antenna element 2 that oppose each other across the substrate 1. In other words, a feature of the substrate 1 is that the third resonance frequency f3 is readily obtained even if a ground of a metal casing or the like is in proximity, since the antenna Q value is comparatively higher than the series resonance as a result of the first ground element 4 and the short circuit pin 3a resonating in parallel in the overlapping region via the dielectric.

The second resonance frequency f2 is adjusted using the ground element length L of the first ground element 4 and the capacitance value of the second capacitive coupling portion 12. The capacitance value of the second capacitive coupling portion 12 is based on the area of the overlapping region of the first ground element 4 and the short circuit pin 3a, and parallel resonance at the frequency f3 is not evident in the case where this is not provided.

Coaxial cable was connected to antenna apparatuses having the above configuration, and reflection evaluation was implemented. The evaluation results are as shown in FIG. 13B. As shown in FIG. 13B, in the case where the antenna apparatus is not provided a folded shape due to only being provided with a first ground element 4 and an inverse F antenna structure not having a folded shape, the impedance of the third resonance frequency f3 obtained by the first ground element 4 is low, making it difficult to obtain sufficient reflection characteristics (VSWR<3).

On the other hand, similarly to the first example, the VSWR characteristics are improved by including a loop configuration having a second resonance frequency f2 resulting from parallel resonance whose antenna Q value is comparatively high, enabling the antenna to be matched to a desired impedance through adjustment to respectively adjacent frequencies, and wideband characteristics to be obtained.

A combination in which the respective antenna Q values of resonance resulting from inverse F power supply to the first antenna element (first resonance), parallel resonance resulting from the loop configuration (second resonance), and parallel resonance resulting from the ground element 4 and the short circuit pin 3a (third resonance) are high is effective in securing bandwidth in the case of bad antenna conditions under which impedance decreases due to antenna elements being in proximity to a ground of a metal casing or the like.

### Example 5

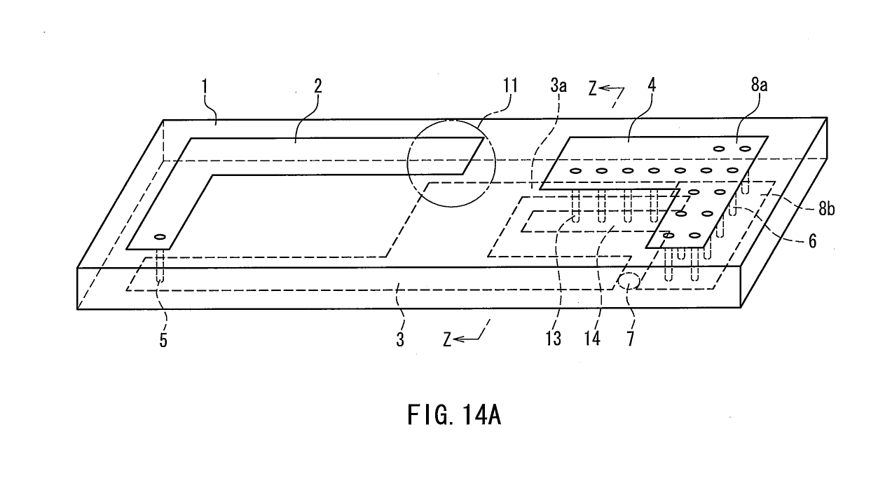

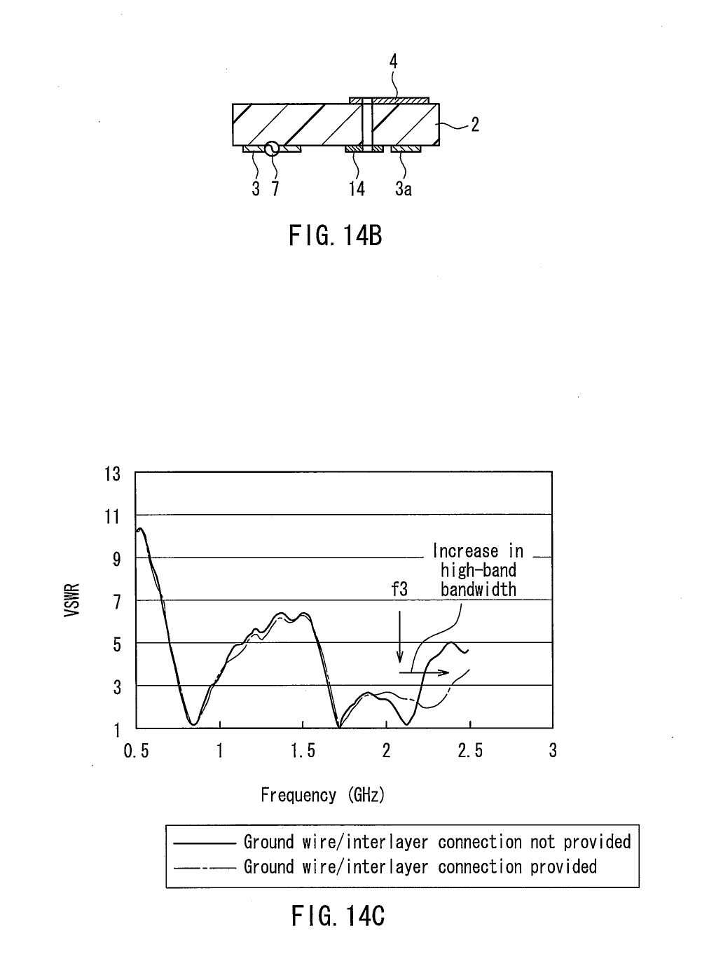

FIG. 14A is a perspective view of an antenna apparatus of Example 5. FIG. 14B is a cross-sectional view of a Z-Z portion in FIG. 14A. FIG. 14C is a characteristics diagram showing the frequency characteristics in both the case where a ground element and a ground plane were connected by a through-hole and were not connected by a through-hole. Note that in FIG. 14A, the same reference numerals are given to constituent elements that are similar to the constituent elements of the antenna apparatus shown in FIG. 1 or the like, and a detailed description thereof will be omitted.

The antenna apparatus of the present example is a configuration in which a short circuit pin 3a, third through-holes 13 and a second ground element 14 have been added to the antenna apparatus shown in FIG. 1 and the like.

The second ground element 14 is disposed on a second surface 1b of the substrate 1 in a position removed from the short circuit pin 3a. The second ground element 14 is provided so as to extend from a second ground plane 8b. A first ground element 4 and the short circuit pin 3a are capacitively coupled. The second ground element 14 is electrically connected to the first ground element 4 via the third through-holes 13.

In the case where, in response to demands for miniaturization of the antenna elements, there is little space for element width and the like and ground element width cannot be adequately secured, the problem of the resonance of the ground element being narrowband arises. Even if the ground line width is expanded at this time to reduce the inductance (L), other bands such as a first resonance frequency f1 will be adversely affected by the ground element being in proximity to the power supply point due to substrate width restrictions.

The antenna apparatus of the present example adjusts impedance by capacitively coupling the short circuit pin 3a and the first ground element 4. Also, establishing continuity with the first ground element 4 at the third through-holes 13 reduces the inductance (L) of the first ground element 4 and enables the bandwidth of the third resonance frequency f3 to be widened, given that there is little mutual influence even if the first ground element 4 and the second ground element 14 are arranged close to the surface of the substrate 1 on which the short circuit pin 3a is disposed.

The overlapping portion of the first ground element 4 and the second ground element 14 and a length equal to the thickness of the substrate 1 can be utilized as radiating elements.

Also, similarly to the second example, as a result of the capacitance (C) between the first ground element 4 and the second ground element 14 that oppose each other via a dielectric increasing, the Q value of the antenna apparatus is controlled to be lower, leading to an increase in antenna bandwidth when combined the above inductance (L) (FIG. 14C).

Also, the third through-holes 13 are desirably arranged in the portions on the feed portion 7 side of the first ground element 4 and the second ground element 14 that bend in an L-shaped from the ground planes. At this time, setting the spacing of the third through-holes 13 to about 2-5 mm, for example, in the case where several GHz is targeted, allows for adequate operation without loss.

### Example 6

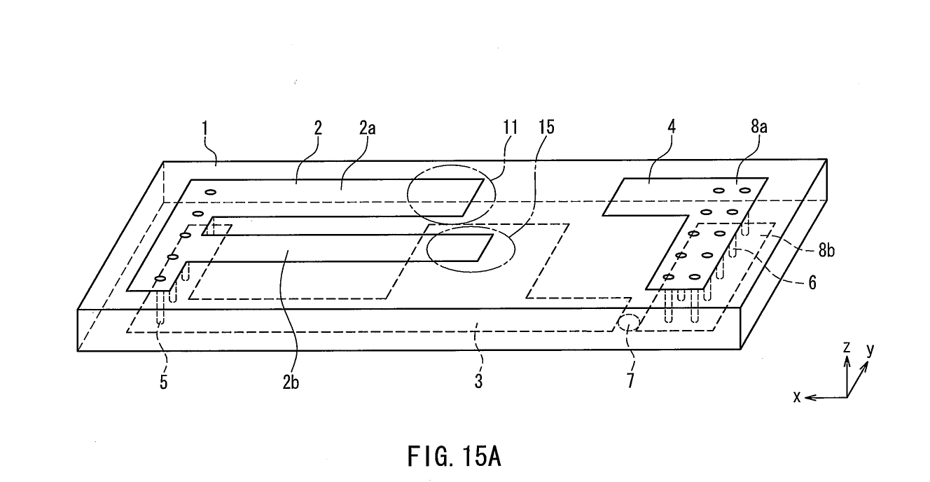

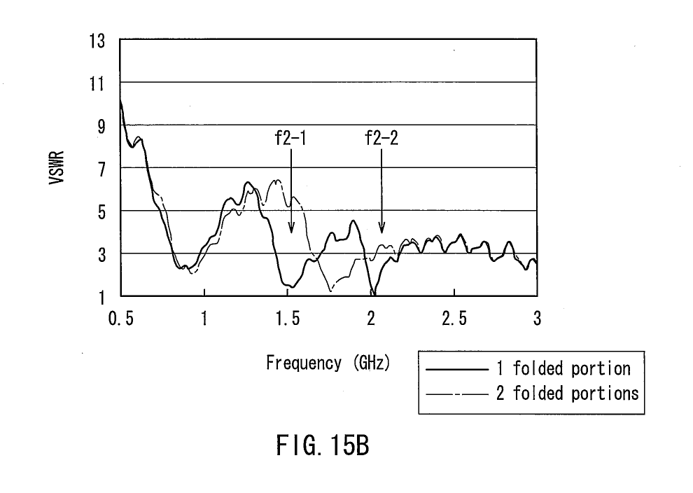

FIG. 15A is a perspective view of an antenna apparatus of Example 6. FIG. 15B is a characteristics diagram showing the frequency characteristics of a structure in which the tip of a first antenna element 3 is branched and a structure in which the tip of a first antenna element 3 is not branched. Note that in FIG. 15A, the same reference numerals are given to constituent elements that are similar to the constituent elements of the antenna apparatus shown in FIG. 1 or the like, and a detailed description thereof will be omitted.

As shown in FIG. 15A, the tip of the first antenna element 3 is branched into at least two, providing the antenna apparatus of the present example with a first folded portion 2a and a second folded portion 2b. The tip of the first folded portion 2a overlaps the second antenna element 2 across the substrate 1 to form a first capacitive coupling portion 11. The tip of the second folded portion 2b overlaps the second antenna element 2 across the substrate 1 to form a third capacitive coupling portion 15. The first folded portion 2a and the second folded portion 2b are formed parallel to each other in the present example.

Note that the spacing between the elements of the first folded portion 2a and the second folded portion 2b is desirably about 2.5×10⁻³λ of the second resonance frequency.

Also, although the first folded portion 2a and the second folded portion 2b both extend in the same direction, they need not extend in the same direction, and may extend in the mutually different directions such as in opposite directions.

Coaxial cable was connected to antenna apparatuses having the above configuration, and reflection evaluation was implemented. The evaluation results are as shown in FIG. 15B. As shown in FIG. 15B, adjusting the element lengths of the first folded portion 2a and the second folded portion 2b and the capacitance values of the first capacitive coupling portion 11 and the third capacitive coupling portion 15 enables resonance frequencies f2-1 and f2-2 to be individually set, and coexist without affecting the first resonance frequency f1 or the third resonance frequency f3.

Also, since the first capacitive coupling portion 11 at the tip of the first folded portion 2a and the third capacitive coupling portion 15 at the tip of the second folded portion 2b have sharp resonance characteristics at a comparatively high antenna. Q value, separate multi-band antenna adjustment is available and effective with respect to frequencies that are separated from each other.

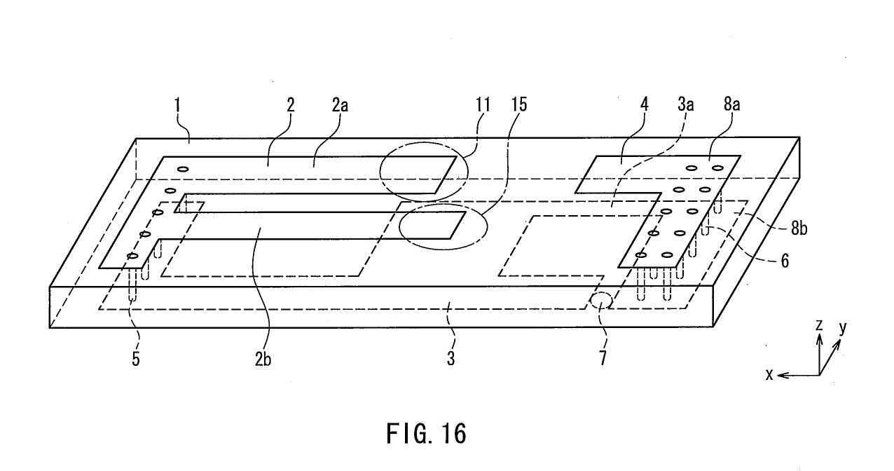

Note that as shown in FIG. 16, a short circuit pin 3a may be added to the antenna apparatus shown in FIG. 15A. Thus, combining an inverse F power supply structure that includes the short circuit pin 3a with the tip folded shape and the first ground element 4 facilitates obtaining radiation resistance even in the case where the short circuit pin 3a is in proximity to a ground of a metal casing or the like, and wideband characteristics can be obtained by matching the antenna to a desired characteristics impedance through adjustment to respectively adjacent frequencies.

### Example 7

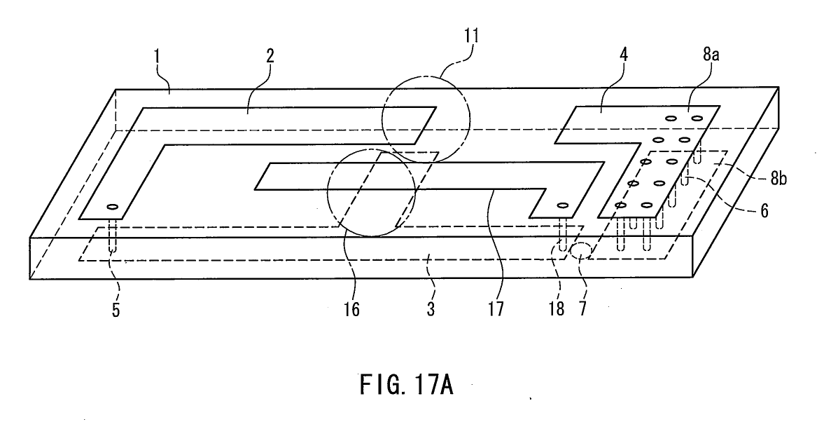

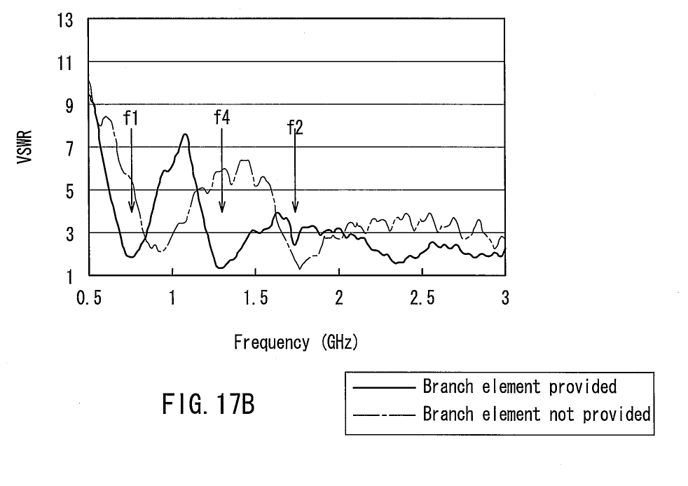

FIG. 17A is a perspective view of an antenna apparatus of Example 7. FIG. 17B is a characteristics diagram showing the frequency characteristics in both the case where a branch element was provided and was not provided. Note that in FIG. 17A, the same reference numerals are given to constituent elements that are similar to the constituent elements of the antenna apparatus shown in FIG. 1 or the like, and a detailed description thereof will be omitted. The antenna apparatus shown in FIG. 17A is a configuration in which a branch element 17 has been added to the antenna apparatus shown in FIG. 1. Note that in FIG. 17B, although a second capacitive coupling portion 12 is not provided, constituting the antenna apparatus using the arrangement of the first antenna element 3 and the first ground element 4, similarly to the first embodiment, enables the respective impedances to be adjusted.

The branch element 17 is formed on a first surface 1a of a substrate 1. The branch element 17 can be formed with a metal conductor such as gold (Au), similarly to a second antenna element 2 and the like. One end of the branch element 17 is electrically connected to the first antenna element 3 via the fourth through-hole 18. A vicinity of the center of the branch element 17 in the longitudinal direction overlaps the second antenna element 2 across the substrate 1 to form a fourth capacitive coupling portion 16. In the fourth capacitive coupling portion 16, the first antenna element 3 and the branch element 17 are capacitively coupled. The capacitance of the fourth capacitive coupling portion 16 is based on the area of the overlapping region of the second antenna element 2 and the branch element 17. The branch element 17 resonates at a fourth resonance frequency f4 shown in FIG. 17B.

Note that the branch element 17, although formed on the first surface 1a of the substrate 1 in the present example, may be formed on the surface on which the second antenna element 2 is formed (second surface 1b of substrate 1 in the present example).

Also, the branch element 17, although provided in a position overlapping the first antenna element 3 in the present example, may be provided in a position that does not overlap the second antenna element 2. In this case, a configuration can be adopted in which the branch element 17 and the second antenna element 2 only overlap in a position adjacent to a feed portion 7 and are electrically connected by a through-hole, for example. In other words, the fourth capacitive coupling portion 16 shown in FIG. 17A is not essential. Note that the fourth capacitive coupling portion 16 is able to control the fourth resonance frequency f4, as a capacitance component of the antenna operating at the branch element 17. On other words, since impedance adjustment of an antenna can be performed using the capacitance component, the present example is effective in performing antenna matching without using a chip constant circuit or the like.

Coaxial cable was connected to antenna apparatuses having the above configuration, and reflection evaluation was implemented. The evaluation results are as shown in FIG. 17B. As shown in FIG. 17B, including the branch element 17 enables a resonance point to be provided in a vicinity of approximately 1.3 GHz (fourth resonance frequency f4).

### Example 8

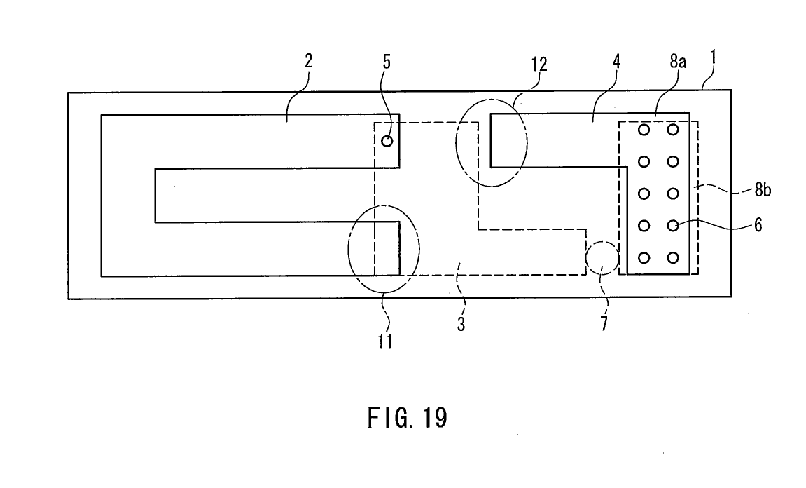

FIG. 19 is a perspective view of an antenna apparatus of Example 8. Note that in FIG. 19, the same reference numerals are given to constituent elements that are similar to the constituent elements of the antenna apparatus shown in FIG. 1 or the like, and a detailed description thereof will be omitted. The antenna apparatus shown in FIG. 19 is a configuration in which the position of the first through-hole 5 and the position of the first capacitive coupling portion 11 in the antenna apparatus shown in FIG. 1 have been changed. Even with such a configuration, an increase in bandwidth can be achieved in the low-band.

### Example 9

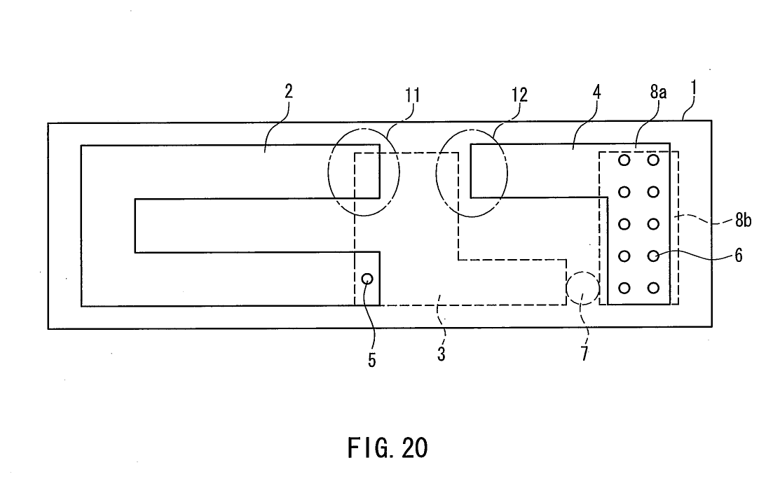

FIG. 20 is a perspective view of an antenna apparatus of Example 9. Note that in FIG. 20, the same reference numerals are given to constituent elements that are similar to the constituent elements of the antenna apparatus shown in FIG. 1 or the like, and a detailed description thereof will be omitted. The antenna apparatus shown in FIG. 20 is a configuration in which the position of the first through-hole 5 in the antenna apparatus shown in FIG. 1 has been changed. Even with such a configuration, an increase in bandwidth can be achieved in lower frequencies.

Note that the substrate 1 in the present embodiment is an example substrate. The first antenna element 3 in the present embodiment is an example of the first antenna element. The second antenna element 2 in the present embodiment is an example of the second antenna element. The first ground element 4 in the present embodiment is an example of the first ground element. The second ground element 14 in the present embodiment is an example of the second ground element. The third ground element 34 in the present embodiment is an example of the third ground element. The first through-hole 5 in the present embodiment is an example of the first interlayer connecting portion. The feed portion 7 in the present embodiment is an example of the feed portion. The first ground plane 8a and the second ground plane 8b in the present embodiment are examples of the ground planes. The short circuit pin 3a in the present embodiment is an example of the short circuit portion. The first capacitive coupling portion 11 in the present embodiment is an example of the first capacitive coupling portion. The second capacitive coupling portion 12 in the present embodiment is an example of the second capacitive coupling portion. The third through-holes 13 in the present embodiment are an example of the second interlayer connecting portion. The fourth through-hole 18 in the present embodiment is an example of the third interlayer connecting portion. The branch element 17 in the present embodiment is an example of the branch element.

The present application is useful in the antenna capable of wireless communication.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An antenna apparatus comprising:
a substrate;
a ground plane formed on an arbitrary surface of the substrate and serving as ground potential;
a first antenna element formed on an arbitrary surface of the substrate;
a feed portion supplying power to the first antenna element;
a second antenna element formed on a different surface of the substrate from the surface on which the first antenna element is formed;
a first ground element extending from the ground plane;
a first interlayer connecting portion formed so as to pass through the substrate, and electrically connecting the first antenna element and the second antenna element;
a first capacitive coupling portion where the first antenna element and the second antenna element overlap or are in proximity to each other across the substrate and are capacitively coupled; and
a loop configuration electrically constituted by the first antenna element, the second antenna element, the first interlayer connecting portion and the first capacitive coupling portion,
wherein the first antenna element, the second antenna element, the ground plane and the first ground element are each formed on an arbitrary surface of the substrate by a conductive pattern.

2. The antenna apparatus according to claim 1,
wherein a plurality of the first interlayer connecting portion are continuously formed in an overlapping region where the first antenna element and the second antenna element constituting the loop configuration oppose each other via the substrate.

3. The antenna apparatus according to claim 1,
wherein the first ground element has a longer element length than an element length of the first antenna element and an element length of the second antenna element, extends at one end from the ground plane, and overlaps or is in proximity to the first antenna element or the second antenna element across the substrate at the other end.

4. The antenna apparatus according to claim 1,
wherein the first antenna element is provided with a short circuit portion electrically connected to the ground plane, and
the antenna apparatus further comprises a second capacitive coupling portion where the short circuit portion and the first ground element overlap or are in proximity to each other across the substrate.

5. The antenna apparatus according to claim 4, further comprising:
a second ground element formed on a different surface of the substrate from the surface on which the first ground element is formed,
a second interlayer connecting portion formed so as to pass through the substrate in an overlapping region where the first ground element and the second ground element oppose each other via the substrate, and electrically connecting the first ground element and the second ground element.

6. The antenna apparatus according to claim 1,
wherein one end on the first antenna element is electrically connected to the first interlayer connecting portion, and the other end branches into a plurality of conductive patterns, and overlaps or is in proximity to the second antenna element across the substrate.

7. The antenna apparatus according to claim 1, further comprising:
a third interlayer connecting portion formed so as to pass through the substrate; and
a branch element electrically connected to the third interlayer connecting portion,
wherein the third interlayer connecting portion is electrically connected to the second antenna element in a vicinity of the feed portion.

8. An electronic device comprising:
the antenna apparatus according to claim 1; and
a casing of which at least part is a conductive portion,
wherein the antenna apparatus is fixed to an arbitrary position of the casing such that the ground plane is electrically connected to the conductive portion of the casing.
